(19) United States
(12) Patent Application Publication
(10) Pub. No.: US 2026/0197287 A1
(43) Pub. Date: Jul. 9, 2026

(54) SMART EYEWEAR SYSTEM, SMART GLASSES, AND METHOD FOR INSTANT MESSAGING PLAYBACK

(71) Applicant: SOLOS TECHNOLOGY (SHENZHEN) LIMITED, Shenzhen (CN)

(72) Inventor: Chi Sum Yu, Shenzhen (CN)

(21) Appl. No.: 19/560,134

(22) Filed: Mar. 9, 2026

Related U.S. Application Data
(63) Continuation of application No. PCT/CN2024/114087, filed on Aug. 23, 2024.

(30) Foreign Application Priority Data
Sep. 7, 2023 (CN) 202311161238.8

(51) Int. Cl. H04L 51/046; G06F 3/16; G06F 40/58; G10L 13/027; H04L 51/214

(52) U.S. Cl. CPC H04L 51/046; G06F 3/165; G06F 40/58; G10L 13/027; H04L 51/214

(57) ABSTRACT

Disclosed are a smart eyewear system, smart glasses, and a method for instant messaging playback. The smart eyewear system includes smart glasses and an intelligent terminal communicatively connected with the smart glasses. The intelligent terminal is configured to obtain at least one instant message and send push information of the at least one instant message to the smart glasses; and the smart glasses are configured to play the at least one instant message in a voice form according to the push information. With the smart eyewear system, the smart glasses, and the method for instant messaging playback, playing instant messages in a voice form is achieved via the smart glasses.

### CROSS-REFERENCE TO RELATED APPLICATIONS

The present disclosure is a Continuation Application of PCT Application No. PCT/CN2024/114087, filed on August 23, 2024, which claims priority to Chinese Patent Application No. 202311161238.8, filed on September 7, 2023, the entire contents of which are hereby incorporated by reference.

### TECHNICAL FIELD

The present disclosure relates to the technical fields of smart wearable products, and in particular to a smart eyewear system, smart glasses, and a method for instant messaging playback.

### BACKGROUND

The smart eyewear system is a data interaction system including smart glasses, an intelligent terminal, and a server. The smart glasses, also referred to as smart spectacles, are devices that, similar to smartphones, have an independent operating system. Users may install software programs provided by software service providers, such as applications and games, on the smart glasses. With the development of smart glasses technology, functions related to the voice capability of smart glasses have become increasingly diversified.

In the prior art, smart glasses may be used to control music playback and adjust volume during calls with other users. However, the voice playback functions are relatively simple and the level of intelligence is relatively low.

### SUMMARY

The present disclosure aims to provide a smart eyewear system, smart glasses, and a method for instant messaging playback, which can solve the problems that the voice functions of smart glasses are relatively simple and the level of intelligence is relatively low.

In one aspect of the present disclosure, the present disclosure provides a smart eyewear system, including: smart glasses and an intelligent terminal communicatively connected with the smart glasses.

The intelligent terminal is configured to obtain at least one instant message and send push information of the at least one instant message to the smart glasses.

The smart glasses are configured to play the at least one instant message in a voice form according to the push information.

In another aspect of the present disclosure, the present disclosure further provides smart glasses, communicatively connected with an instant messaging server. The smart glasses are configured to obtain push information of at least one instant message sent by the instant messaging server.

The smart glasses are further configured to play the at least one instant message in a voice form according to the push information.

In another aspect of the present disclosure, the present disclosure further provides a method for instant messaging playback, applied to a smart eyewear system. The smart eyewear system includes smart glasses and an intelligent terminal communicatively connected with the smart glasses, and the method includes:

obtaining, by the intelligent terminal, at least one instant message, and sending, by the intelligent terminal, push information of the at least one instant message to the smart glasses; and

playing, by the smart glasses, the at least one instant message in a voice form according to the push information.

It can be seen from the foregoing embodiments of the present disclosure that the smart glasses are communicatively connected with an intelligent terminal. The intelligent terminal is configured to obtain instant messages and send push information of the instant messages to the smart glasses. The smart glasses are configured to play the instant messages in a voice form according to the push information. Therefore, instant messages received by the intelligent terminal can be played by voice via the smart glasses, thereby enriching the functions of the smart glasses, improving the intelligence level of the smart glasses, and providing convenience for users to access instant messages.

### BRIEF DESCRIPTION OF DRAWINGS

In order to more clearly illustrate the technical solutions in the embodiments of the present disclosure, the accompanying drawings required for describing the embodiments or the prior art will be briefly introduced below. It is apparent that the accompanying drawings described below merely illustrate some embodiments of the present disclosure.

FIG. 1 is a schematic structural view of a smart eyewear system according to one embodiment of the present disclosure;

FIG. 2 is a schematic view of a hardware structure of the smart eyewear system according to one embodiment of the present disclosure;

FIG. 3 is a schematic view of a modular structure of the smart eyewear system according to one embodiment of the present disclosure;

FIG. 4 is a schematic view of a setting interface of an intelligent terminal for setting an instant massaging function according to one embodiment of the present disclosure;

FIG. 5 is a schematic view of a setting interface of the intelligent terminal for setting the smart glasses to play at least one instant massage according to one embodiment of the present disclosure;

FIG. 6 is a schematic view of a setting interface of the intelligent terminal for setting the smart glasses to play a favorites list according to one embodiment of the present disclosure;

FIG. 7 is a schematic view illustrating playing the at least one instant message via the smart glasses according to one embodiment of the present disclosure;

FIG. 8 is a schematic view of an application environment of the smart glasses according to one embodiment of the present disclosure; and

FIG. 9 is a flow chart of a method for instant messaging playback according to one embodiment of the present disclosure.

### DESCRIPTION OF EMBODIMENTS

To make the objectives, technical solutions, and advantages of the present disclosure clearer, the following provides a more detailed description of the present disclosure in conjunction with the accompanying drawings and exemplary embodiments. It should be understood that the specific embodiments described herein are merely illustrative of the present disclosure and are not intended to limit its scope.

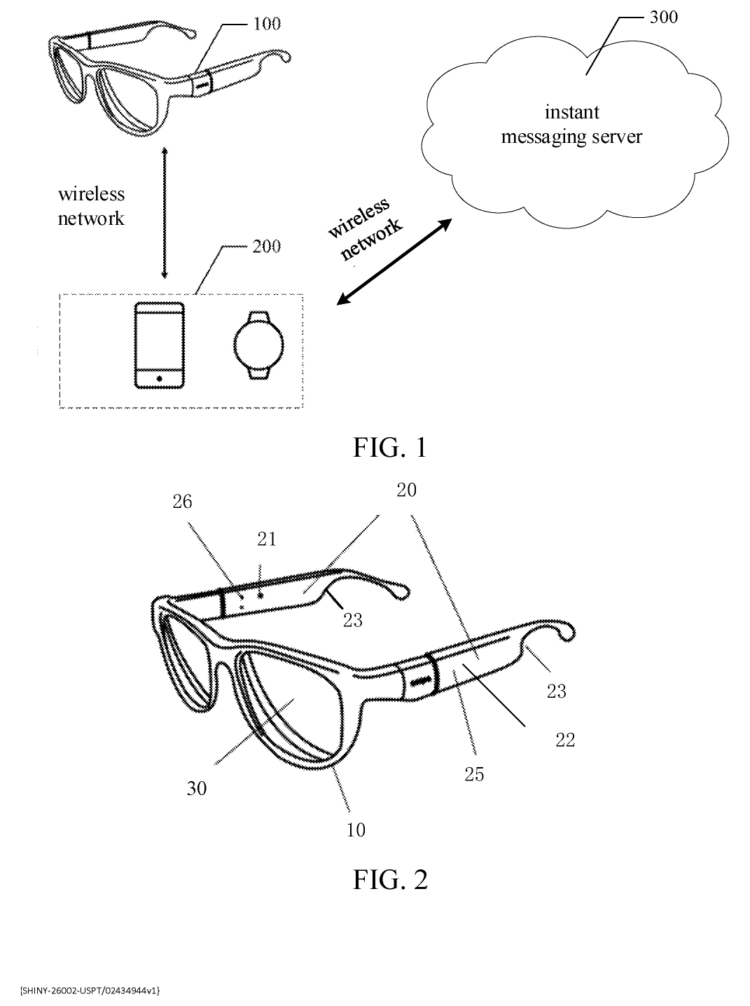

As shown in FIG. 1, which is a schematic structural view of a smart eyewear system according to some embodiments of the present disclosure. The system includes smart glasses 100, an intelligent terminal 200, and an instant messaging server 300.

The smart glasses 100 are communicatively connected with the intelligent terminal 200 via a wireless network. The wireless network includes Bluetooth^{®}, WIFI, and mobile communication networks such as 4G or 5G, and Bluetooth^{®}is preferred. The intelligent terminal 200 is communicatively connected with the instant messaging server 300 via a mobile communication network such as 4G or 5G, or via WIFI.

The intelligent terminal 200 is configured to obtain at least one instant message from the instant messaging server 300 via an instant messaging application and to send push information of the at least one instant message to the smart glasses 100.

The smart glasses 100 are configured to obtain the push information of the at least one instant message and play the at least one instant message in a voice form according to the push information.

Specifically, the intelligent terminal 200 is installed with an instant messaging application, including but not limited to WhatsApp, Messages, Teams, WeChat, LINES, Signal, Telegram and other IM applications, for obtaining instant messages.

The intelligent terminal 200 may further include a built-in translation engine configured to translate instant messages in a non-local language into instant messages in a local language. The intelligent terminal 200 may also invoke a third-party translation engine for translation. The third-party translation engine may be disposed in the instant messaging server 300 or in another device having a wireless or wired connection with the intelligent terminal 200.

The local language includes a national language, a regional dialect, or another local language set by the user.

The intelligent terminal 200 may further include a text-to-speech engine configured to convert instant messages from a text format into a voice format and send the voice-format messages to the smart glasses 100. The smart glasses 100 directly play items of the instant messages in a voice form, where the items to be played are preset by the intelligent terminal 200, thereby implementing voice playback of the instant messages.

The smart glasses 100 may include a text-to-speech engine. The intelligent terminal 200 may send the obtained instant messages to the smart glasses 100 in the form of push information. The push information includes items of the instant messages. The smart glasses 100 convert the received push information from a text format into a voice format via the text-to-speech engine and play items of the instant messages in the voice form, thereby implementing voice playback of the instant messages.

The items of the instant messages include, but are not limited to, a sender identity of the instant message, a name of the instant messaging application via which the instant message is obtained, and message content of the instant message. The push information includes the above items.

The instant messaging server 300 is provided with modules corresponding to the instant messaging applications, configured to cooperate with the instant messaging applications in the intelligent terminal 200 to implement functions of the respective instant messaging applications.

In the embodiments of the present disclosure, the smart eyewear system includes smart glasses and an intelligent terminal communicatively connected with the smart glasses. The intelligent terminal is configured to obtain at least one instant message and send push information of the at least one instant message to the smart glasses; and the smart glasses are configured to play the at least one instant message in a voice form according to the push information, thereby implementing voice playback of instant messages received by the intelligent terminal, enriching functions of the smart glasses, improving the intelligence level of the smart glasses, and providing convenience for users to access instant messages.

In another embodiment, the intelligent terminal 200 may be a smart mobile terminal such as a smartphone, or a wearable smart device such as a smartwatch. The intelligent terminal 200 includes a processor and a memory. The memory stores a mobile application and an instant messaging application. A user may invoke the mobile application via the processor to control the intelligent terminal to wirelessly connect to the smart glasses, for example, via Bluetooth^{®}, WIFI, or mobile communication networks. The mobile application is invoked to set the smart glasses to play instant messages by operations, such as enabling or disabling an instant messaging function of the smart glasses, and configuring playback modes of instant messages.

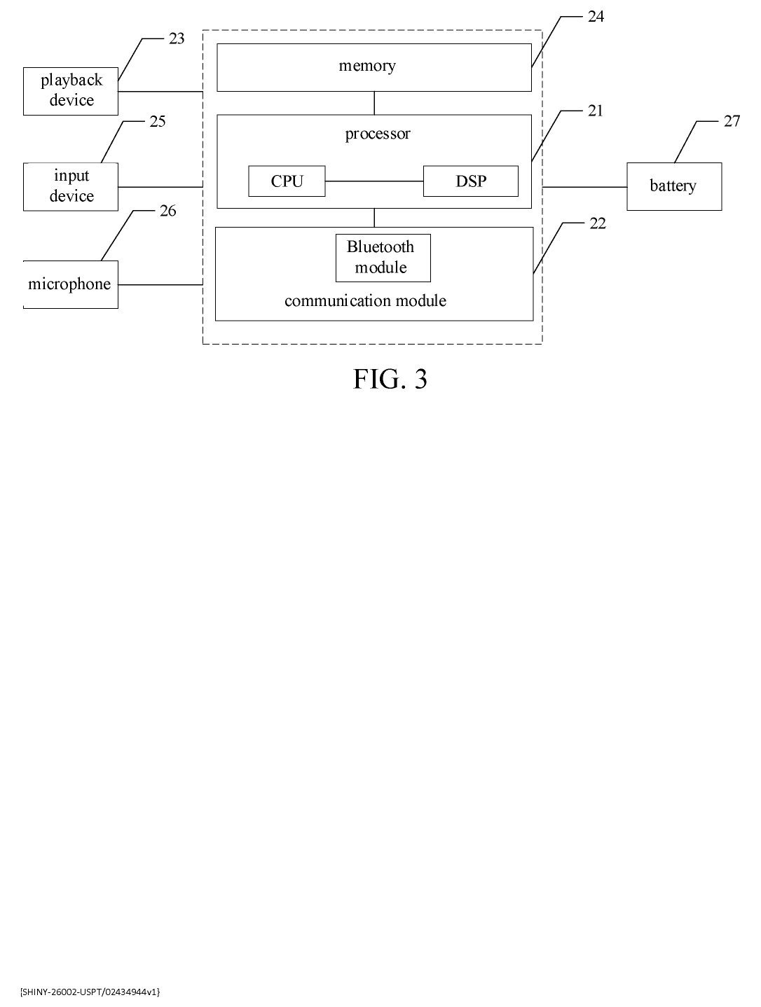

As shown in FIG. 2 and FIG. 3, FIG. 2 is a schematic structural view of the smart eyewear system according to some embodiments of the present disclosure; and FIG. 3 is a schematic view of a modular structure of the smart eyewear system according to some embodiments of the present disclosure. It should be noted that the structural view of the smart glasses shown in FIG. 2 is merely an example. Components such as a processor, a memory, an input device, a playback device, and a microphone may be arranged as required and are not limited to the positions shown in the figure. For convenience of description, only parts related to the embodiments of the present disclosure are illustrated. The smart glasses 100 may include: a front frame 10 and two temples 20 connected to the front frame 10. Lenses 30 may be embedded in the front frame 10.

The front frame 10 and the temples 20 may be detachably connected or fixedly connected.

A processor 21, a communication module 22, a playback device 23, and a memory 24 are disposed in the front frame 10 and/or the temple 20.

The communication module 22 is configured to communicate with an intelligent terminal having a communication module with the same function. The communication module 22 includes a Bluetooth^{®} module.

The communication module 22 may further include a WIFI module and a mobile communication module.

The playback device 23 may be a speaker, and may include a single speaker or multiple speakers. Preferably, a pair of speakers is respectively disposed on the left and right temples.

The processor 21 is electrically connected to the communication module 22, the playback device 23, and the memory 24.

The processor 21 is further configured to convert instant messages from a text format into a voice format via a built-in text-to-speech engine, and control the playback device 23 to play the instant messages in the voice format.

The processor 21 includes a central processing unit (CPU), and may further include a digital signal processor (DSP). The DSP is configured to process audio signals. The DSP is connected to and controlled by the CPU.

The smart glasses 100 may further include an input device 25, a microphone 26, and a battery 27.

The input device 25 may be a button or a touch sensor, configured to obtain user input operations.

The microphone 26 is configured to collect sound.

The battery 27 is configured to supply power to the smart glasses.

In another embodiment, the intelligent terminal 200 is further configured to set a playback mode for the smart glasses to play the at least one instant message, and the playback mode includes at least one of: playback content, playback duration, playback order, and playback language. That is, one of the playback modes may be set, or any two or more thereof may be set in combination.

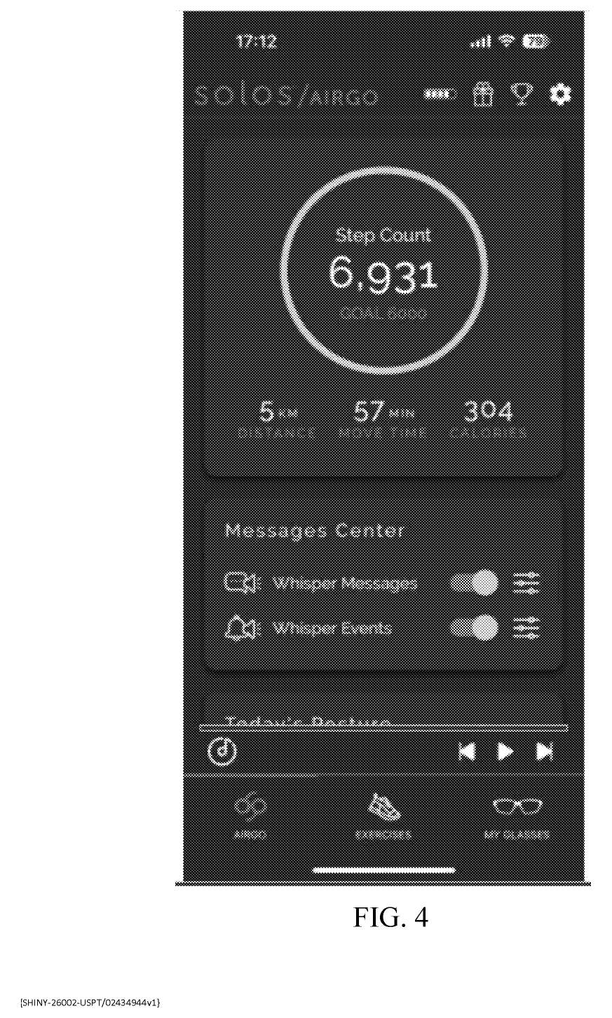

In another embodiment, the intelligent terminal 200 may set the smart glasses 100 to enable or disable a function of playing instant messages. Referring to FIG. 4, it shows an interactive interface of a mobile application running on the intelligent terminal 200. On the interface, a button labeled "Whisper Messages" is provided for enabling or disabling the function of playing instant messages. By clicking or sliding the button, the function of playing instant messages may be turned on or off. When the function is disabled, the smart glasses 100 reject receiving push information of the instant messages sent by the intelligent terminal 200, or do not play the instant messages after receiving the push information. When the function is enabled, the smart glasses 100 receive the push information and play the instant messages in a voice form.

In another embodiment, the intelligent terminal 200 is configured to set the smart glasses 100 to play at least one instant message in at least one designated instant messaging application and from at least one designated sender.

Specifically, a user may define a favorites list via a mobile application of the intelligent terminal 200. Several instant messaging users may be added to the favorites list, and voice playback via the smart glasses may be enabled for instant messages received from these users.

For example, according to a user setting instruction, when the intelligent terminal 200 enables an instant messaging function in a voice form for an instant messaging user named S in an instant messaging application A, the smart glasses 100 play instant messages received from S in the instant messaging application A, but do not play instant messages sent by other users other than S in the instant messaging application A or in other instant messaging applications other than A.

Different senders may be designated for different time periods. For example, during working hours, designated senders may include company colleagues or company group; during non-working hours, designated senders may include family members.

Priority levels may also be set for designated senders. A designated sender may remain designated at all times without being restricted by time periods.

In another embodiment, the intelligent terminal 200 is configured to set items for the smart glasses 100 to play the at least one instant message.

The sender of the instant message (i.e., the instant messaging user) has an identity, which may include a name, a number, or the like.

Specifically, the intelligent terminal 200 may set the smart glasses 100 to play only the name of the sender; the name of the sender and the application name; the name of the sender and the message content; or the name of the sender, the application name, and the message content.

In another embodiment, the intelligent terminal 200 may further set a correspondence relationship between a time at which push information of the instant message is received and items of the instant message to be played by the smart glasses 100, such that the smart glasses 100 play corresponding items of the instant message according to the time at which the current push information of the instant message is received.

Specifically, multiple time periods may be set, for example: working hours on weekdays (9:00 AM to 6:00 PM), leisure hours on weekdays (6:00 PM to 10:00 PM), and all-day hours on holidays (9:00 AM to 10:00 PM). If push information of the instant message is received during working hours, only the name of the sender or the message content may be played. If push information of the instant message is received during leisure hours, the name of the sender and the message content may be played. If push information of the instant message is received during holidays, the name of the sender, the application name, and the message content may be played. The above examples are merely illustrative. Users may set playback content according to their own habits or requirements, and the settings are not limited to the examples described above.

In another embodiment, the intelligent terminal 200 is further configured to set at least one language for the smart glasses 100 to play the at least one instant message, such that the smart glasses 100 play the items in the at least one instant message in the at least one language.

The multiple languages may include English, Chinese, French, and the like. The name of the sender, the application name, and the message content in the instant message may be played in a mixed manner using different languages. For example, the name of the sender may be played in Chinese, while the message content may be played in English.

Alternatively, the playback language of the instant message may be uniformly set to a single language.

In another embodiment, the intelligent terminal 200 is further configured to set a playback duration or a character count for the smart glasses 100 to play the at least one instant message, such that the smart glasses 100 play the at least one instant message according to the playback duration or the character count. The playback of the instant message stops when the set playback duration or character count is reached.

In another embodiment, the intelligent terminal 200 is further configured to set items in a first received instant message to include a sender identity and to set items of each instant message starting from a second received instant message to not include the sender identity, when the smart glasses 100 continuously receive a plurality of instant messages sent by a same instant messaging user within a preset duration. That is, the playback items of the first received instant message include the sender identity, while the playback items of each instant message starting from the second received instant message do not include the sender identity.

Specifically, the preset duration may be set to 60 seconds. If multiple instant messages from the same instant messaging user are received within 60 seconds, the name of the sender, the application name, and the message content in the first received instant message may be played. Starting from the second received instant message until the last instant message received within the 60 seconds, only the message content is played without playing the name of the sender, thereby saving playback time and reducing power consumption.

In another embodiment, the intelligent terminal 200 may further set an interval duration or a continuous duration for instant messages continuously received by the smart glasses 100 from the same instant messaging user. That is, when the interval time between two instant messages from the same sender that do not exceed the interval duration or instant messages from the same sender are received within the continuous duration, the above method is applied to such scenarios. Specifically, starting from the second instant message, only the message content is played.

In another embodiment, the intelligent terminal 200 is configured to set the smart glasses 100 to play the sender identity of the instant message, the application name from which the instant message is obtained, and the message content. For example, the played voice may be: "You have a message from C on X: Do you have time to have dinner together tonight?"

Further, in another embodiment, an input device 25 is disposed in the front frame and/or at least one of the two temples of the smart glasses.

The intelligent terminal 200 is further configured to set the smart glasses 100 to stop or skip playing a current instant message in response to an input action received via the input device 25 during playback of the current instant message. Skipping playback of the instant message refers to stopping playback of the current instant message and starting playback of the next instant message.

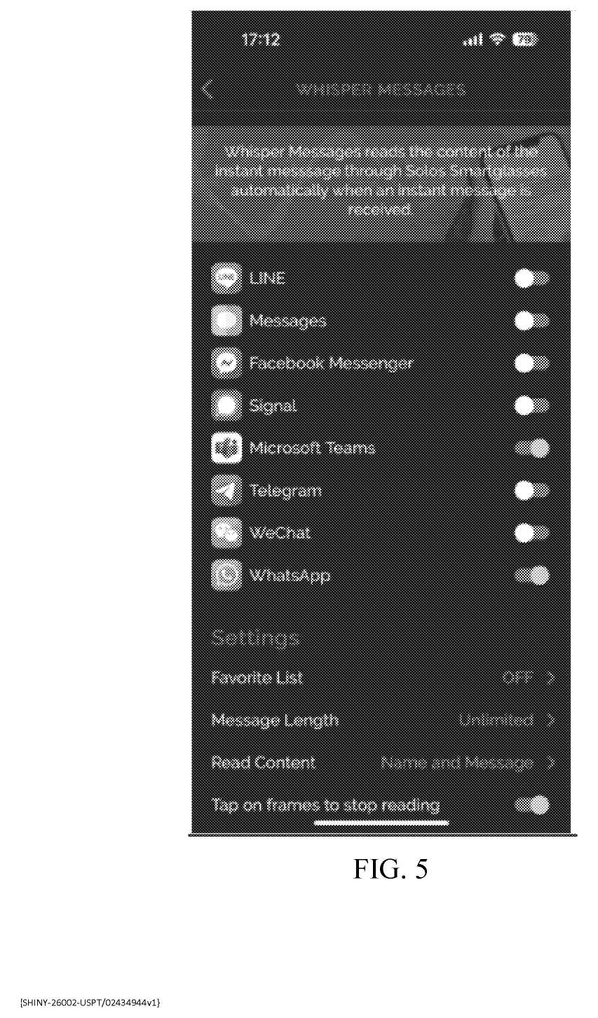

Referring to FIG. 5, FIG. 5 illustrates a setting interface of the intelligent terminal 200 for configuring playback of instant messages by the smart glasses 100. The switch buttons provided on the setting interface include, but are not limited to: buttons for setting the smart glasses 100 to play instant messages corresponding to respective designated instant messaging applications, wherein FIG. 5 shows switch buttons for LINE, Messages, Facebook Messenger, Signal, Microsoft Teams, Telegram, WeChat and WhatsApp; a switch button "Favorite List" for setting a favorite list to be played by the smart glasses 100, wherein a plurality of instant messaging users are set in the favorite list, and the instant messaging users are enabled to play received instant messages via voice broadcast of the smart glasses; a button "Message Length" for setting a playback length of instant voice messages played by the smart glasses 100; a button "Read Content" for setting playback content; and a switch button "Tap on frames to stop reading" for stopping the playback of instant messages via an action input by the input device 25. Other switch buttons may also be provided on the setting interface. The illustration in FIG. 5 is merely an example, and does not limit the number and type of the switch buttons provided.

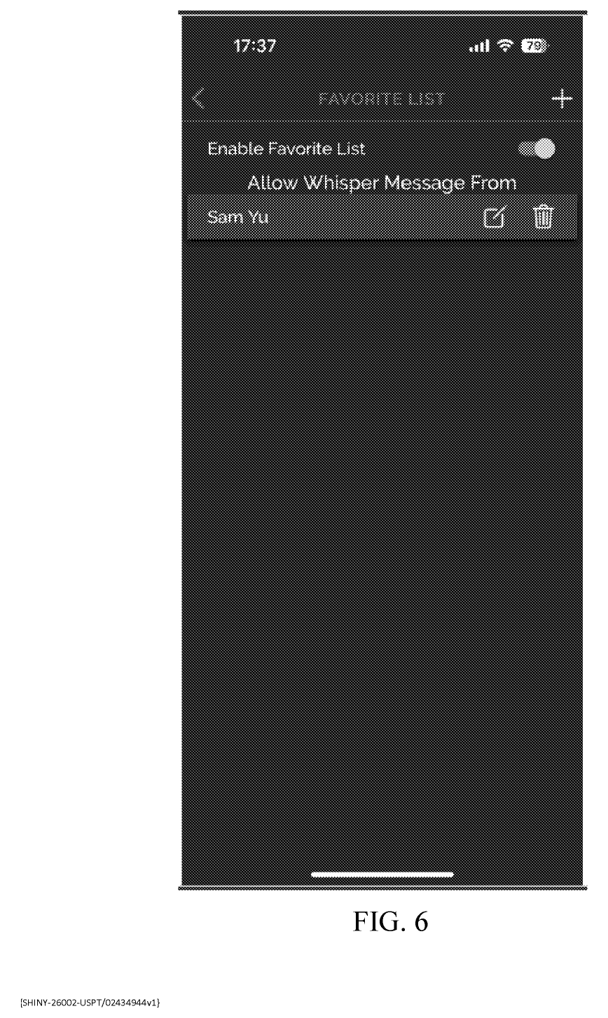

Referring to FIG. 6, FIG. 6 illustrates a specific interface of the intelligent terminal 200 for setting the favorite list to be played by the smart glasses 100. The switch button "Enable Favorite List" is shown. On this interface, instant messaging users in the Favorite List may also be configured, such as Sam Yu shown in FIG. 6. When the switch button is turned on, the smart glasses 100 can play, in the voice form, instant messages from instant messaging users included in the Favorite List.

Further, in another embodiment, the intelligent terminal 200 is further configured to enable or disable automatic adjustment of a playback volume for the smart glasses 100 to play the at least one instant message according to a detected result of environmental noise.

When automatic adjustment of the playback volume is enabled according to the detected result of the environmental noise, the intelligent terminal 200 acquires ambient sounds and performs environmental noise detection based on the sounds, and automatically adjusts the playback volume of the speaker for playing the instant message according to the detected result of the environmental noise.

Specifically, if the environmental noise is greater than a preset noise threshold, the smart glasses 100 increase the playback volume of the instant message; if the environmental noise is less than a preset noise threshold, the smart glasses 100 decrease the playback volume of the instant message.

When automatic adjustment of the playback volume is disabled according to the detected result of the environmental noise, the intelligent terminal 200 does not adjust the playback volume of the speaker for playing the instant message based on the detected result of the environmental noise.

Further, in another embodiment, the intelligent terminal 200 is configured to disable or enable the smart glasses 100 to play the at least one instant message in at least one designated instant messaging application in the voice form.

For example, the intelligent terminal 200 may enable the voice playback function for instant messages from instant messaging application A and instant messaging application B for the smart glasses 100, and disable the voice playback function for instant messages from instant messaging application C. In this case, the smart glasses 100 may play, in the voice form, instant messages sent by the intelligent terminal 200 from instant messaging application A and instant messaging application B, but do not play instant messages sent by the intelligent terminal 200 from instant messaging application C.

Further, in another embodiment, the smart glasses 100 include a light-emitting device, which may be, for example, a light-emitting diode (LED) and its surrounding circuit. Light emitted by the light-emitting device may be perceived by the eyes of the wearer. As an example, the light-emitting device may be disposed at a connection portion between the front frame and the temple of the smart glasses 100, such as at a hinge position.

The intelligent terminal 200 is further configured to set the smart glasses 100 to remind a user via a visual alert and/or a sound alert when the smart glasses 100 receive the push information. The intelligent terminal 200 is further configured to set the smart glasses 100 to not play the at least one instant message but to notify a user via a visual alert emitted from the light-emitting device when the smart glasses 100 receive the push information in a do-not-disturb mode, and to make the smart glasses 100 automatically play the at least one instant message after exiting the do-not-disturb mode. The do-not-disturb mode includes a quiet mode.

The do-not-disturb mode may also include, for example, a meeting mode and a rest mode. When in the do-not-disturb mode, the user does not wish the smart glasses 100 to automatically play instant messages sent by the intelligent terminal 200.

The user may control the smart glasses to enter or exit the do-not-disturb mode by setting a do-not-disturb time period on the intelligent terminal 200. Alternatively, the user may set an entry gesture and an exit gesture for the do-not-disturb mode on the intelligent terminal 200. When the smart glasses 100 detect the entry gesture of the user, they enter the do-not-disturb mode; and when the smart glasses 100 detect the exit gesture of the user, they exit the do-not-disturb mode.

The visual alert may be a flashing signal, and the flashing frequency may be set by the user via the intelligent terminal 200. The sound alert may be a sound signal, and the sound volume may be set by the user via the intelligent terminal 200.

Further, in another embodiment, the intelligent terminal 200 is further configured to translate the at least one instant message into text-format messages in a local language via a built-in translation engine, to convert the text-format messages into voice-format messages via a built-in text-to-speech engine, and to send push information of the voice-format messages to the smart glasses 100, such that the smart glasses 100 play the voice-format messages via the playback device 23.

Alternatively, the intelligent terminal 200 is further configured to translate the at least one instant message into voice-format messages in a local language via a third-party translation engine, and to send push information of the voice-format messages to the smart glasses 100, such that the smart glasses play the voice-format messages via the playback device 23.

The voice-format message may include formats such as Mandarin voice, Cantonese voice, English voice, and Japanese voice. A message converted into a Mandarin voice format corresponds to a simplified Chinese text format; a message converted into a Cantonese voice format corresponds to a traditional Chinese text format; a message converted into an English voice format corresponds to an English text format; and a message converted into a Japanese voice format corresponds to a Japanese text format.

The instant message may be translated into a text format in the above local language via a built-in translation engine, and then the text format in the local language may be converted into a voice format in the local language via a text-to-speech engine.

Alternatively, the instant message may be directly translated into a voice format in the above local language via a third-party translation engine.

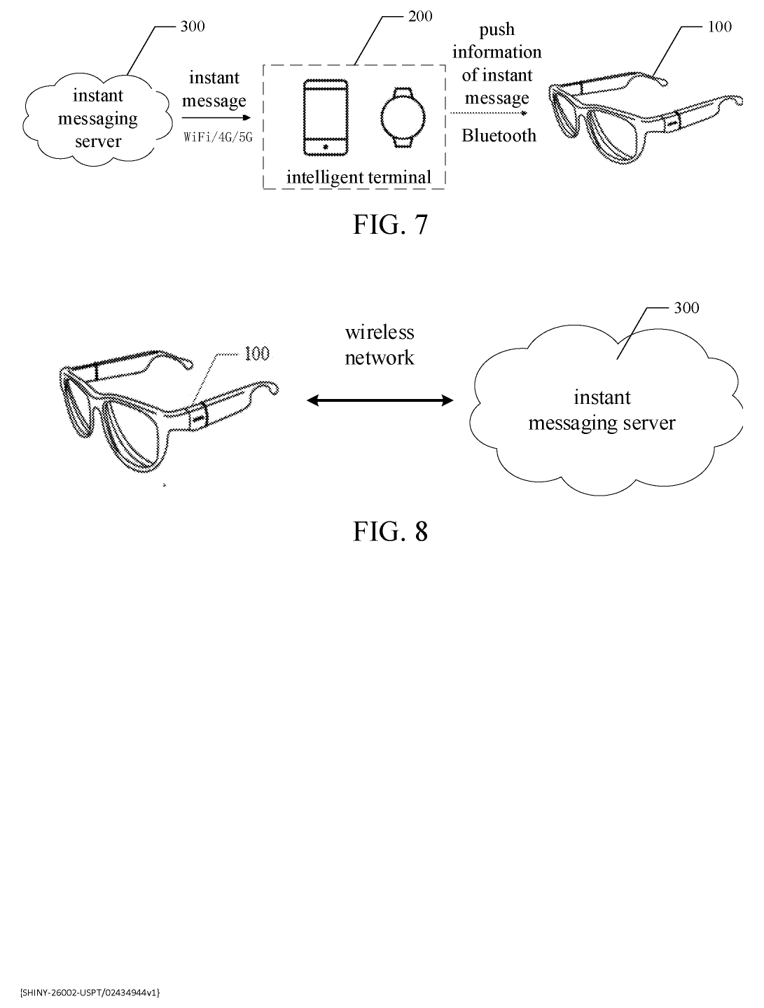

By way of example, a process for the smart glasses 100 implementing playback of instant messages received by the intelligent terminal 200 is described with reference to FIG. 7. When an instant messaging (IM) application receives an instant message, the intelligent terminal 200 (illustrated in FIG. 7 as a smart phone or a smart watch) sends push information of the received instant message to the smart glasses 100 via Bluetooth^{®}. The push information includes items of the instant message, such as the name of the sender, the IM application name, and the content of the instant message. After receiving the push information, the smart glasses 100 convert the instant message in the push information from a text format into a voice format via a built-in text-to-speech engine of the smart glasses 100, and play the name of the sender, the IM application name, and the message content via left and right stereo speakers.

Referring to FIG. 8, an embodiment of the present disclosure further provides smart glasses that are communicatively connected with an instant messaging server and transmit data therewith. The smart glasses 100 is exemplarily shown in FIGS. 1 to 3, and the instant messaging server 300 is exemplarily shown in FIG. 1.

The smart glasses 100 are communicatively connected with the instant messaging server 300 via a wireless network. The wireless network includes Bluetooth^{®}, WIFI, and mobile communication networks such as 4G or 5G, preferably WIFI or a mobile communication network.

Specifically, the instant messaging application is installed in the smart glasses 100.

The instant messaging server 300 is provided with a module corresponding to the instant messaging application. The module is configured to obtain instant messages sent by users and to send the instant messages to the instant messaging application in the smart glasses 100, thereby implementing functions of the instant messaging application.

The smart glasses 100 are configured to obtain push information of the at least one instant message from the instant messaging server 300 via the instant messaging application, and play the at least one instant message in a voice form according to the push information. The push information includes various items in the instant message.

A translation engine may also be provided in the smart glasses 100 and the translation engine is configured to convert instant messages in a non-local language into instant messages in a local language.

The smart glasses 100 may also invoke a third-party translation engine to convert instant messages in a non-local language into instant messages in a local language. The third-party translation engine may be disposed on the intelligent terminal 200 or the instant messaging server 300.

A text-to-speech engine may also be provided in the smart glasses 100. The smart glasses 100 convert the received push information from a text format into a voice format via the text-to-speech engine, and play the items of the instant message in the voice format. The items to be played are preset by the instant messaging server 300, thereby playing the items of the instant message in a voice form.

The items of the instant message include, but are not limited to: a sender identity of the instant message, a name of the instant messaging application via which the instant message is received, and message content of the instant message. The push information includes the above items.

The smart glasses 100 are configured to obtain push information of instant messages sent by the instant messaging server 300, and play the instant messages in the voice form according to the push information.

In the embodiments of the present disclosure, the smart glasses are communicatively connected with the instant messaging server. The smart glasses are configured to obtain push information of instant messages sent by the instant messaging server, and to play the instant messages in the voice form according to the push information, thereby implementing voice playback of instant messages on the smart glasses, enriching functions of the smart glasses, improving intelligence of the smart glasses, and providing convenience for users to read instant messages.

In another embodiment, the instant messaging server 300 is configured to set a playback mode for playing the instant message on the smart glasses 100. The smart glasses 100 are configured to play the at least one instant message according to the playback mode set by the instant messaging server 300. The playback mode includes one or any combination of: playback content, playback duration, playback order, and playback language.

The playback content refers to items of the instant message to be played. The items include, but are not limited to: a sender identity of the instant message, a name of the instant messaging application via which the instant message is received, and message content of the instant message. The smart glasses 100 may, according to settings of the instant messaging server 300, play one or any combination of the sender identity, the name of the corresponding instant messaging application, and the message content of the instant message.

The playback duration refers to a length of time for playing the instant message, for example, playing for 5 seconds, playing half of the total duration of the instant message, or playing until 5 seconds before the end of the instant message.

The playback order refers to an order in which multiple instant messages are played when received. For example, playing instant messages in the order received, or giving priority to playing the most recently received instant message.

The playback language refers to a language used when playing the instant message, for example, Chinese, English, or French.

In another embodiment, the instant messaging server 300 is configured to set the smart glasses 100 to play instant messages from designated instant messaging applications and designated senders. The smart glasses 100 are configured to play instant messages from the designated instant messaging applications and designated senders via the playback device 23 according to the settings of the instant messaging server 300.

In another embodiment, the instant messaging server 300 is configured to set multiple languages for playing the instant message on the smart glasses 100. The smart glasses 100 play items of the instant message in the multiple languages according to the settings of the instant messaging server 300.

Specifically, translation engines for multiple languages are stored in the memory 24, and the processor 21 may invoke these translation engines to translate specified content into corresponding languages. The multiple languages may include English, Chinese, French, etc. The processor 21 controls the playback device 23 to play the name of the sender, the application name, and the message content of the instant message according to the set languages. That is, the name of the sender, the application name, and the message content may be played in a mixed manner using different languages. For example, the name of the sender may be played in Chinese, while the message content may be played in English.

In another embodiment, the instant messaging server 300 is configured to set a playback duration or a character count for playing the instant message on the smart glasses 100. The smart glasses 100 play the instant message according to the playback duration or character count set by the instant messaging server 300. When playback of the instant message reaches the set playback duration or character count, playback of the instant message is stopped.

In another embodiment, when the smart glasses 100 continuously obtain a plurality of instant messages sent by the same instant messaging user within a preset duration, the instant messaging server 300 is configured to set the playback items of the first received instant message to include the sender identity, and to set the playback items of each instant message starting from the second received instant message not to include the sender identity. The smart glasses 100 are further configured, according to the settings of the instant messaging server 300, such that when multiple instant messages from the same instant messaging user are continuously received within the preset duration, starting from the second received instant message, only the message content in the playback items of the instant message is played. That is, the playback items of the first received instant message include the sender identity, while the playback items of each instant message starting from the second received instant message do not include the sender identity, and only the message content in the playback items is played.

Specifically, the input device 25 may be a button or a touch sensor.

The button or touch sensor may be disposed in the front frame and/or the temples. The instant messaging server 300 is configured to set the smart glasses 100 such that, when playing the instant message, the smart glasses 100 respond to an input action received via the input device 25 to stop playback or skip playback of the instant message. The smart glasses 100 are configured such that, when the speaker is playing the instant message, in response to the input action sensed by the button, the speaker is controlled to stop playback or skip playback of the current instant message.

The input action may be a click, a touch, or a slide.

The input device 25 may also be a touch sensor disposed in the temples. The smart glasses 100 are further configured such that, when the speaker is playing the instant message and a sliding gesture toward the ear of the user ear is sensed by the touch sensor on the temple, the volume is increased or decreased, or a sliding gesture away from the ear of the user ear is sensed by the touch sensor on the temple during playback of the instant message, the volume is decreased or increased.

Further, in another embodiment, the smart glasses 100 further include a microphone 26 disposed in the front frame and/or the temples.

The instant messaging server 300 is configured to enable or disable the smart glasses 100 to automatically adjust the playback volume of the instant message based on detected ambient sounds. The smart glasses 100 are further configured to obtain ambient sounds via the microphone 26, to perform environmental noise detection based on the sounds, and to automatically adjust the speaker volume for playing the instant message according to the detected result of environmental noise.

Specifically, if the environmental noise is greater than a preset noise threshold, the smart glasses 100 increase the playback volume of the instant message; if the environmental noise is less than a preset noise threshold, the smart glasses 100 decrease the playback volume of the instant message.

Further, in another embodiment, the instant messaging server 300 is configured to enable or disable the smart glasses 100 to play the instant messages obtained from all or part of the instant messaging applications in the voice form. The smart glasses 100 are further configured, according to the settings of the instant messaging server 300, to enable or disable voice playback of the instant messages obtained from all or part of the instant messaging applications.

Further, in another embodiment, the smart glasses 100 are further configured to remind a user via a visual alert and/or a sound alert when receiving the push information. The smart glasses 100 are further configured, according to the settings of the instant messaging server 300, to not play the instant message when receiving the push information of the instant message in a do-not-disturb mode, and to notify the user of the received instant message via a visual alert emitted by a lighting device. After exiting the do-not-disturb mode, the smart glasses 100 automatically play the instant message. The do-not-disturb mode includes a quiet mode.

The user may control the activation or deactivation of the do-not-disturb mode of the smart glasses by setting do-not-disturb time periods on the instant messaging server 300, or by defining do-not-disturb entry and exit gestures on the instant messaging server 300. When the smart glasses 100 detect the user performing the entry gesture, they enter the do-not-disturb mode; when the smart glasses 100 detect the user performing the exit gesture, they exit the do-not-disturb mode.

The visual alert may be a flashing signal, and the flash frequency can be set by the user via the instant messaging server 300. The sound alert may be a sound signal, and the sound volume may be set by the user via the instant messaging server 300.

Further, in another embodiment, the smart glasses 100 are configured to translate the instant message into the text-format message in a local language via a built-in translation engine, to convert the text-format message into a voice-format message via a built-in text-to-speech engine, and to play the voice-format message.

The smart glasses 100 are also configured to translate the instant message into the voice-format message in a local language via a third-party translation engine, and to obtain and play the voice-format message.

In this embodiment, the smart glasses implement voice playback of instant messages according to the settings of the instant messaging server, further enriching functionality, enhancing intelligence, and providing convenience to the user.

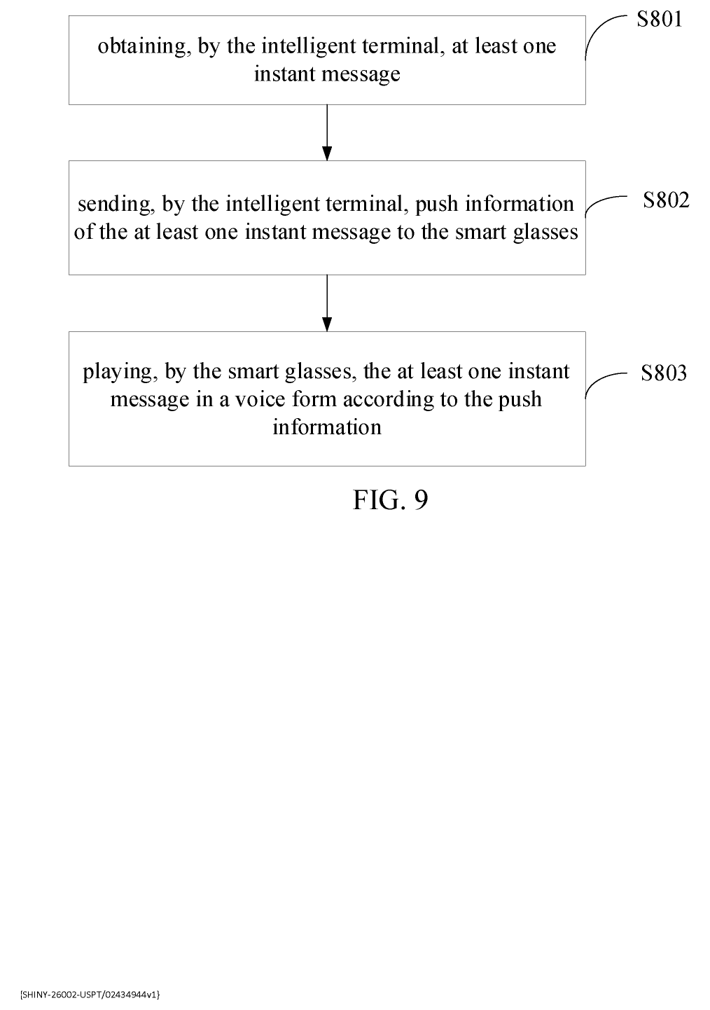

Referring to FIG. 9, the present embodiment also provides a method for instant messaging playback, applicable to the smart eyewear system of the above embodiments. In this system, the intelligent terminal of the smart eyewear system obtains instant messages via an instant messaging application and sends push information of the instant message to the smart glasses within the system. The smart glasses then play the instant message in a voice form according to the push information. The method includes the following steps:

S801: obtaining, by the intelligent terminal, at least one instant message;

S802: sending, by the intelligent terminal, push information of the at least one instant message to the smart glasses; and

S803: playing, by the smart glasses, the at least one instant message in a voice form according to the push information.

The specific content of this embodiment can be referred to in the descriptions of the previous embodiments.

In this embodiment, the smart glasses communicatively connect to the intelligent terminal, the intelligent terminal obtains instant messages and sends the push information to the smart glasses, and the smart glasses play the instant messages in a voice form according to the push information. This achieves voice playback of instant messages received by the intelligent terminal on the smart glasses, enriching the functionality of the smart glasses, enhancing their intelligence, and providing convenience for users to read instant messages.

Further, in another embodiment, prior to step S803, the method further includes: setting, by the intelligent terminal, a playback mode for the smart glasses to play the at least one instant message. The playback mode includes at least one of: playback content, playback duration, playback order, and playback language.

Further, in another embodiment, the step of setting, by the intelligent terminal, a playback mode for the smart glasses to play the at least one instant message, includes: setting, by the intelligent terminal, the smart glasses to play at least one instant message in at least one designated instant messaging application and from at least one designated sender.

Further, in another embodiment, the step of setting, by the intelligent terminal, a playback mode for the smart glasses to play the at least one instant message, includes: setting, by the intelligent terminal, items for the smart glasses to play the least one instant message.

Further, in another embodiment, the step of setting, by the intelligent terminal, a playback mode for the smart glasses to play the at least one instant message, includes: setting, by the intelligent terminal, at least one language for the smart glasses to play the at least one instant message, such that the smart glasses play the items in the at least one instant message in the at least one language.

Further, in another embodiment, the step of setting, by the intelligent terminal, a playback mode for the smart glasses to play the at least one instant message, includes: setting, by the intelligent terminal, a playback duration or a character count for the smart glasses to play the at least one instant message, such that the smart glasses play the at least one instant message according to the playback duration or the character count.

Further, in another embodiment, the step of setting, by the intelligent terminal, a playback mode for the smart glasses to play the at least one instant message, includes: setting, by the intelligent terminal, items in a first received instant message to include a sender identity and items in each of succeeding instant messages starting from a second received instant message to not include the sender identity, when the smart glasses continuously receive a plurality of instant messages sent by a same sender within a preset duration.

Further, in another embodiment, the step of setting, by the intelligent terminal, a playback mode for the smart glasses to play the at least one instant message, includes: setting, by the intelligent terminal, the smart glasses to stop or skip playing a current instant message in response to an input action received via the input device during playback of the current instant message, wherein an input device is provided in a front frame and/or at least one of two temples of the smart glasses.

Further, in another embodiment, the step of setting, by the intelligent terminal, a playback mode for the smart glasses to play the at least one instant message, includes: enabling or disabling, by the intelligent terminal, automatic adjustment of a playback volume of the smart glasses for playing the at least one instant message based on a detected result of environmental noise.

Further, in another embodiment, the step of setting, by the intelligent terminal, a playback mode for the smart glasses to play the at least one instant message, includes: enabling or disabling, by the intelligent terminal, the smart glasses to play the at least one instant message in at least one designated instant messaging application in the voice form.

Further, in another embodiment, the method further includes setting, by the intelligent terminal, the smart glasses to remind a user via a visual alert and/or a sound alert when the smart glasses receive the push information; and setting, by the intelligent terminal, the smart glasses to notify a user via a visual alert when the smart glasses receive the push information in a do-not-disturb mode, to make the smart glasses play the at least one instant message after exiting the do-not-disturb mode. The do-not-disturb mode includes a quiet mode.

Further, in another embodiment, the method further includes: translating, by the intelligent terminal, the at least one instant message into text-format messages in a local language via a built-in translation engine, converting, by the intelligent terminal, the text-format messages into voice-format messages via a built-in text-to-speech engine, and sending, by the intelligent terminal, push information of the voice-format messages to the smart glasses, to thereby play the voice-format messages by the smart glasses.

Alternatively, translating, by the intelligent terminal, the at least one instant message into voice-format messages in a local language via a third-party translation engine, and sending, by the intelligent terminal, push information of the voice-format messages to the smart glasses, to thereby play the voice-format messages by the smart glasses.

It should be noted that, for the above method embodiments, for simplicity of description, they are expressed as a series of combined actions. However, those skilled in the art should understand that the present disclosure is not limited by the described sequence of actions, as certain steps may be performed in other orders or simultaneously. Additionally, those skilled in the art should recognize that the embodiments described in the specification are preferred embodiments, and the actions and modules involved are not necessarily all required by the present disclosure.

In the above embodiments, the description of each embodiment emphasizes different aspects. Parts not detailed in one embodiment can be referred to in the relevant descriptions of other embodiments.

The above provides a description of the smart eyewear system, the smart glasses, and the method for instant messaging playback provided by the present disclosure. For those skilled in the art, modifications can be made to the specific implementation methods and application scope based on the concepts of the embodiments of this application. Therefore, the content of this specification should not be construed as limiting the scope of the present disclosure.

What is claimed is:

1. A smart eyewear system, comprising smart glasses and an intelligent terminal communicatively connected with the smart glasses;
wherein the intelligent terminal is configured to obtain at least one instant message and send push information of the at least one instant message to the smart glasses; and
wherein the smart glasses are configured to play the at least one instant message in a voice form according to the push information.

2. The smart eyewear system according to claim 1, wherein the intelligent terminal is further configured to set a playback mode for the smart glasses to play the at least one instant message, and the playback mode comprises at least one of: playback content, playback duration, playback order, and playback language.

3. The smart eyewear system according to claim 2, wherein the intelligent terminal is further configured to set the smart glasses to play at least one instant message in at least one designated instant messaging application and from at least one designated sender.

4. The smart eyewear system according to claim 2, wherein the intelligent terminal is further configured to set the playback content for the smart glasses to play the at least one instant message.

5. The smart eyewear system according to claim 2, wherein the intelligent terminal is further configured to set at least one language for the smart glasses to play the at least one instant message, such that the smart glasses play the playback content in the at least one instant message in the at least one language.

6. The smart eyewear system according to claim 2, wherein the intelligent terminal is further configured to set a playback duration or a character count for the smart glasses to play the at least one instant message, such that the smart glasses play the at least one instant message according to the playback duration or the character count.

7. The smart eyewear system according to claim 2, wherein the playback content comprises items; and wherein the intelligent terminal is further configured to, when the smart glasses continuously receive a plurality of instant messages sent by a same sender within a preset duration, set items in a first received instant message to include a sender identity and set items in each of succeeding instant messages starting from a second received instant message to not include the sender identity.

8. The smart eyewear system according to claim 2, wherein an input device is provided in a front frame and/or at least one of two temples of the smart glasses; and
wherein the intelligent terminal is further configured to set the smart glasses to stop or skip playing a current instant message in response to an input action received via the input device during playback of the current instant message.

9. The smart eyewear system according to claim 2, wherein the intelligent terminal is further configured to enable or disable automatic adjustment of a playback volume of the smart glasses for playing the at least one instant message based on a detected result of environmental noise.

10. The smart eyewear system according to claim 2, wherein the intelligent terminal is further configured to enable or disable the smart glasses to play at least one instant message in at least one designated instant messaging application in the voice form.

11. The smart eyewear system according to claim 1, wherein the intelligent terminal is further configured to set the smart glasses to remind a user via a visual alert and/or a sound alert when the smart glasses receive the push information; and
wherein the intelligent terminal is further configured to set the smart glasses to notify the user via the visual alert when the smart glasses receive the push information in a quiet mode, and to make the smart glasses play the at least one instant message after exiting the quiet mode.

12. The smart eyewear system according to claim 1, wherein the intelligent terminal is further configured to translate the at least one instant message into text-format messages in a local language via a built-in translation engine, to convert the text-format messages into voice-format messages via a built-in text-to-speech engine, and to send push information of the voice-format messages to the smart glasses, to thereby play the voice-format messages by the smart glasses.

13. The smart eyewear system according to claim 1, wherein the intelligent terminal is further configured to translate the at least one instant message into voice-format messages in a local language via a third-party translation engine, and to send push information of the voice-format messages to the smart glasses, to thereby play the voice-format messages by the smart glasses.

14. Smart glasses, communicatively connected with an instant messaging server, wherein the smart glasses are configured to obtain push information of at least one instant message sent by the instant messaging server; and
wherein the smart glasses are further configured to play the at least one instant message in a voice form according to the push information.

15. The smart glasses according to claim 14, wherein the smart glasses are further configured to play the at least one instant message according to a playback mode set by the instant messaging server, and the playback mode comprises at least one of: playback content, playback duration, playback order, and playback language.

16. The smart glasses according to claim 15, wherein the smart glasses comprise: a front frame and two temples connected to the front frame; and
wherein the smart glasses further comprise an input device, a playback device, and a microphone provided on the front frame and/or at least one of the two temples.

17. The smart glasses according to claim 15, wherein the smart glasses are configured to play at least one instant message in at least one designated instant messaging application and from at least one designated sender via the playback device according to settings of the instant messaging server.

18. The smart glasses according to claim 15, wherein the smart glasses are further configured to play the playback content in the at least one instant message in at least one language set by the instant messaging server.

19. The smart glasses according to claim 15, wherein the smart glasses are further configured to play the at least one instant message according to a playback duration or a character count set by the instant messaging server.

20. The smart glasses according to claim 15, wherein the playback content comprises items; and wherein the smart glasses are further configured to, when the smart glasses continuously receive a plurality of instant messages sent by a same sender within a preset duration, play the plurality of instant messages according to settings of the instant messaging server, wherein items in a first received instant message include a sender identity and items in each of succeeding instant messages starting from a second received instant message do not include the sender identity.

21. The smart glasses according to claim 16, wherein the input device comprises a button; and
wherein the smart glasses are further configured to control at least one speaker to stop or skip playing a current instant message in response to an input action sensed on the button during playback of the current instant message.

22. The smart glasses according to claim 16, wherein the input device comprises at least one touch sensor disposed on at least one of the two temples;
the smart glasses are further configured to, during playback of the at least one instant message, increase or decrease a playback volume of at least one speaker in response to a gesture sliding toward a user ear on a corresponding temple sensed by the at least one touch sensor, or to decrease or increase the playback volume of at least one speaker in response to a gesture sliding away from the user ear on the corresponding temple sensed by the at least one touch sensor.

23. The smart glasses according to claim 16, wherein the smart glasses are further configured to, based on settings of the instant messaging server, obtain ambient sounds via the microphone, to detect environmental noise according to the ambient sounds, and to automatically adjust a playback volume for playing the at least one instant message based on a detected result of the environmental noise.

24. The smart glasses according to claim 15, wherein the smart glasses are further configured to enable or disable playing the at least one instant message in at least one designated instant messaging application in the voice form according to settings of the instant messaging server.

25. The smart glasses according to claim 14, wherein the smart glasses are further configured to remind a user via a visual alert and/or a sound alert when receiving the push information; and
wherein the smart glasses are further configured to notify the user via the visual alert when receiving the push information in a quiet mode, and to play the at least one instant message after exiting the quiet mode according to settings of the instant messaging server.

26. The smart glasses according to claim 14, wherein the smart glasses are further configured to translate the at least one instant message into text-format messages in a local language via a built-in translation engine, to convert the text-format messages into voice-format messages via a built-in text-to-speech engine, to thereby play the voice-format messages.

27. The smart glasses according to claim 14, wherein the smart glasses are further configured to translate the at least one instant message into voice-format messages in a local language via a third-party translation engine, to thereby play the voice-format messages.

28. A method for instant messaging playback, applied to a smart eyewear system, wherein the smart eyewear system comprises smart glasses and an intelligent terminal communicatively connected with the smart glasses, and the method comprises:
obtaining, by the intelligent terminal, at least one instant message, and sending, by the intelligent terminal, push information of the at least one instant message to the smart glasses; and
playing, by the smart glasses, the at least one instant message in a voice form according to the push information.

29. The method according to claim 28, wherein before the step of playing, by the smart glasses, the at least one instant message in a voice form according to the push information, the method further comprises:
setting, by the intelligent terminal, a playback mode for the smart glasses to play the at least one instant message, wherein the playback mode comprises at least one of: playback content, playback duration, playback order, and playback language.

30. The method according to claim 29, wherein the step of setting, by the intelligent terminal, a playback mode for the smart glasses to play the at least one instant message, comprises:
setting, by the intelligent terminal, the smart glasses to play at least one instant message in at least one designated instant messaging application and from at least one designated sender.

31. The method according to claim 29, wherein the playback content comprises items; and wherein the step of setting, by the intelligent terminal, a playback mode for the smart glasses to play the at least one instant message, comprises:
setting, by the intelligent terminal, items in a first received instant message to include a sender identity and items in each of succeeding instant messages starting from a second received instant message to not include the sender identity, when the smart glasses continuously receive a plurality of instant messages sent by a same sender within a preset duration.
